(19) United States
(12) Patent Application Publication
(10) Pub. No.: US 2017/0208355 A1
(43) Pub. Date: Jul. 20, 2017

(54) METHOD AND APPARATUS FOR NOTIFYING A USER WHETHER OR NOT THEY ARE WITHIN A CAMERA'S FIELD OF VIEW

(71) Applicant: MOTOROLA SOLUTIONS, INC, CHICAGO, IL (US)

(72) Inventors: PRZEMYSLAW L BOGUCKI, KRAKÓW (PL); KRZYSZTOF MINIOR, RUDAWA (PL); ROBERT MROWIEC, LISZKI (PL); BARTLOMIEJ OLEJAK, KRAKÓW (PL); GRZEGORZ MARCIN PAWLIK, WIELICZKA (PL)

(21) Appl. No.: 15/320,360

(22) PCT Filed: Jul. 15, 2014
(86) PCT No.: PCT/PL2014/000079

§ 371 Date: Dec. 20, 2016

(51) Int. Cl. H04N 21/4223; H04N 1/00; H04N 21/258; H04N 21/488; H04N 21/442

(52) U.S. Cl. CPC H04N 21/4223; H04N 21/4882; H04N 21/44218; H04N 21/25841; H04N 1/00204

(57) ABSTRACT

A method and apparatus for notifying a user whether or not they are within a camera's field of view is provided herein. During operation equipment will receive a location of a user device. The equipment will also receive locations of cameras along with camera parameters. The equipment will determine whether or not the user device is within a field of view of a camera based on the location of the user device, the location of the cameras, and potentially the camera parameters. An indication of whether or not the device is within the field of view of a camera will be provided to a user.

### FIELD OF THE INVENTION

The present invention generally relates to notifying a user whether or not they are within a camera's field of view.

### BACKGROUND OF THE INVENTION

In many public-safety scenarios it is desirable for a public-safety officer to be within a field of view of a camera recording an incident. (i.e., visible to the camera). For example, recorded video is often critical for event analysis and is acceptable evidence in many courts of law. Therefore, it would be beneficial to provide public-safety officers (e.g., police officers, firemen, paramedics, border patrol agents, . . . , etc.) information as to whether or not they are within a field of view of a camera. It would also be beneficial to direct any public-safety officer to a field of view of a camera when the officer is not within a field of view of a camera.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a general operational environment for a public-safety officer.

FIG. 2 illustrates a camera's field of view.

FIG. 3 is a block diagram of the server of FIG. 1.

FIG. 4 is a block diagram of a user device of FIG. 1.

FIG. 5 is a flow chart showing operation of the server of FIG. 3.

FIG. 6 is a flow chart showing operation of the user device of FIG. 4 in accordance with a first embodiment.

FIG. 7 is a flow chart showing operation of the user device of FIG. 4 in accordance with a second embodiment.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a method and apparatus for notifying a user whether or not they are within a camera's field of view is provided herein. During operation equipment will receive a location of a user device. The equipment will also receive locations of cameras along with camera parameters. The equipment will determine whether or not the user device is within a field of view of a camera based on the location of the user device, the location of the cameras, and potentially the camera parameters. An indication of whether or not the device is within the field of view of a camera will be provided to a user.

In a first embodiment, a server will perform the functions of the above equipment, sending a notification to a user device as to whether or not they are within view of a camera. In a second embodiment, a user device will perform the calculations and determine whether or not the user device is within view of a camera.

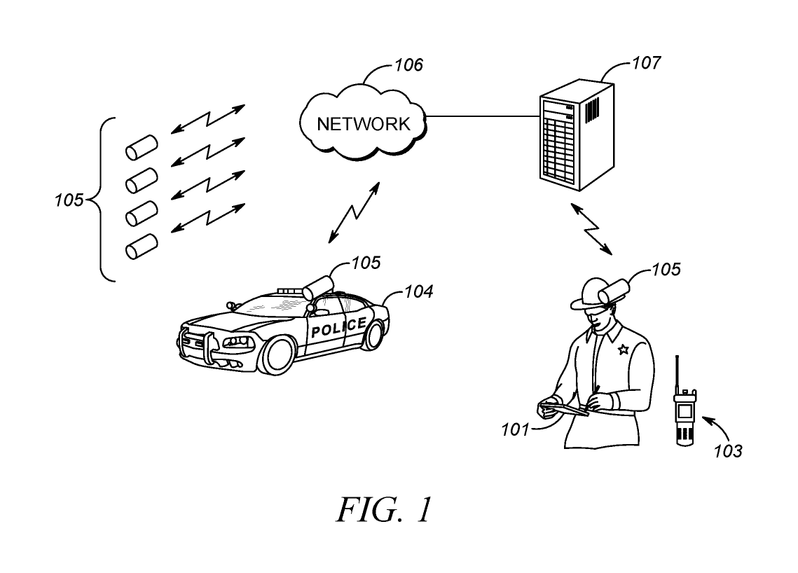

Turning now to the drawings wherein like numerals designate like components, FIG. 1 illustrates a general operational environment for a public-safety officer. As shown in FIG. 1, multiple cameras 105 are providing a live video feed and/or still images of objects within their Field Of View (FOV). Cameras 105 may be embodied in various physical system elements, including a standalone device, or as functionality in a Network Video Recording device (NVR), a Physical Security Information Management (PSIM) device, a camera bundled within a smartphone device, a camera worn by officer 101, a camera mounted on a public-safety vehicle 104, etc. Furthermore, the cameras 105 could be mounted on any mobile entity such as a vehicle (terrestrial, aerial or marine) or mobile user 101 (such as a camera mounted on a user's helmet or lapel) or a mobile robot.

Public-safety officers 101 are usually associated with radio 103 that is equipped with a graphical user interface. Radio 103 can be any portable electronic device, including but not limited to a standalone display or monitor, a handheld computer, a tablet computer, a mobile phone, a police radio, a media player, a personal digital assistant (PDA), or the like, including a combination of two or more of these items.

During operation, cameras 105 continuously capture a real-time video stream. Along with the video steam, cameras 105 may also capture metadata that includes the geographic location of a particular camera 105 (e.g., GPS coordinates) and an “absolute direction” (such as N, W, E, S) associated with each video stream during the course of operation. Additional information such as a camera resolution, focal length, camera resolution and type of camera, camera view angle, and/or time of the day may be captured as metadata.

It should be noted that the direction of the camera refers to the direction of the camera's field of view in which camera 105 is recording. Thus, the metadata may provide information such as, but not limited to the fact that camera 105 is located at a particular location and capturing a particular identified field of view (FOV) at a particular time, with a particular camera type, and/or focal length. In a simple form, a camera captures video, still images, or thermal images of a FOV. The FOV identified in the metadata may simply comprises compass directions (e.g., camera pointing at 105 degrees). In a more advanced embodiment, the FOV identified in the metadata will comprise location information along with level information and compass direction and focal length used, such that a field of view may be determined.

The metadata as described above can be collected from a variety of sensors (not shown) such as location sensors (such as via Global Positioning System (GPS)), gyroscopes, compasses, and/or accelerometers associated with the camera. The metadata may also be indirectly derived from a Pan-Tilt-Zoom functionality of the camera. Furthermore, the aforementioned sensors may either be directly associated with the camera or associated with the mobile entity with which the camera is coupled such as a smartphone, the mobile user, a vehicle, or a robot.

In the first embodiment, the metadata is transmitted from the camera to server 107 so that server 107 may calculate whether or not device 103 is within any camera 105 field of view. In the second embodiment this information is transmitted to device 103 so that device 103 may calculate whether or not device 103 is within any camera 105 field of view.

As can be readily understood by those skilled in the art, the transmission of video and the supporting metadata may traverse one or more communication networks 106 such as one or more of wired and/or wireless networks. Furthermore, the video and metadata may first be transmitted to server 107 which may post-process the video and metadata feed and then transmit the feed to one or more devices 103. Note that server 107 may record and keep a copy of the video and metadata feed for future use for example to transmit the recorded video and metadata to an investigator for investigative purposes at a later time.

As described above, the metadata may comprise a current location of a camera 105 (e.g., 42 deg 04′ 03.482343″ lat., 88 deg 03′ 10.443453″ long. 727 feet above sea level), and a compass direction to which the camera is pointing (e,g, 270 deg. from north), and a level direction of the camera (e.g., −25 deg. from level). This information can then be passed to device 103 and/or server 107 so that the camera's location, direction, and level can be used to determine the camera's field of view.

In some embodiments, such as when the camera has a pan-tilt-zoom (PTZ) schedule, or is coupled with a mobile entity such as a mobile user, a vehicle, or a robot, the metadata is expected to change during the course of the video feed. In other words, as the camera moves, or captures a different field of view, the metadata will need to be updated accordingly. Thus, at a first time, devices 103 and/or server 107 may be receiving first metadata from a camera 105, and at a second time, device 103 and/or server 107 may be receiving second (differing) metadata from the camera 105.

Each device 103 is associated with context-aware circuitry (compass, gyroscope, accelerometers, location finding equipment, and other sensors) used to determine a location and orientation. This information may also be provided to server 107. Thus, device 103 and/or server 107 may “know” the field of views of cameras 105 and the location and orientation of device 103. Based with this knowledge, server 107 (first embodiment) and/or device 103 (second embodiment) may calculate whether or not device 103 is within a field of view of any camera 105. If server 107 is calculating whether or not device 103 is within a camera's field of view, this information may be provided to device 103 through intervening network 106.

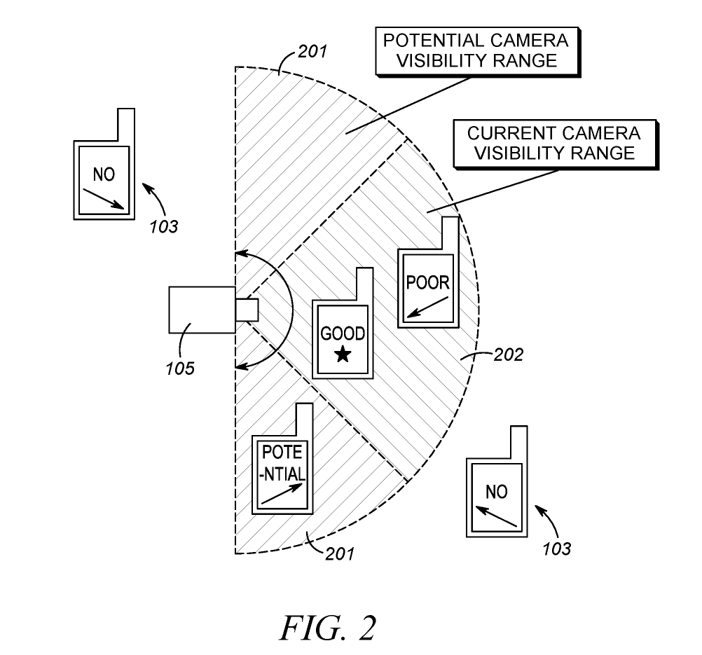

Device 103 may comprise a graphical user interface (GUI) that illustrates whether or not device 103 is within any camera's field of view, potentially within any camera's field of view, or outside any camera's field of view. Additionally, device 103 may use the graphical user interface to give a direction and distance needed for device 103 to move so that device 103 is within a camera's field of view. This is illustrated in FIG. 2.

FIG. 2 illustrates a camera's field of view as it relates to device 103 and its graphical user interface. As shown in FIG. 2, as device 103 moves, device 103 may indicate to the user whether or not device 103 is within a field of view of camera 105. This indication may simply be text, stating for example, “good visibility”, “no visibility”, or “potential visibility”. Information as to the direction to improve visibility may also be provided. Thus, when device 103 is outside areas 201 or 202, they are not visible by camera 105 and a “no visibility” message will be provided to the user along with a direction needed to move in order to be placed within the field of view of camera 105. Although not shown, a distance needed to travel may also be provided to the user. When device 103 lies within areas of potential visibility 201, or within areas of visibility 202, this information will also be provided to the user of device 103.

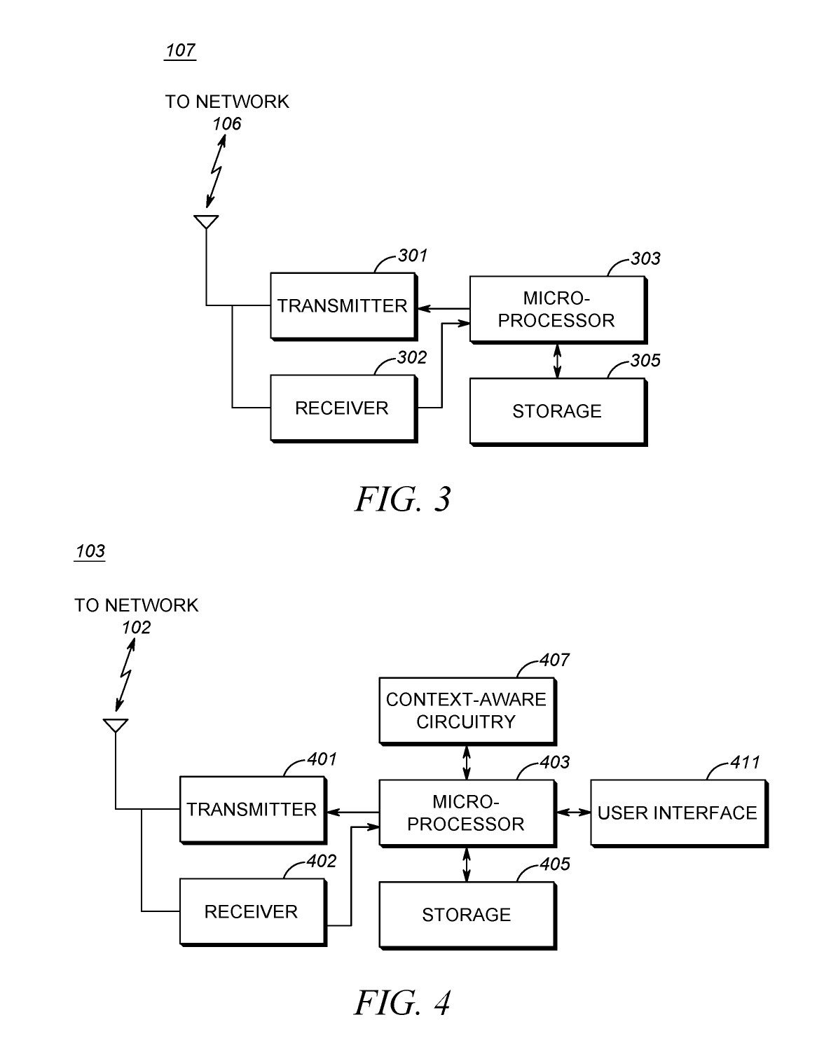

FIG. 3 is a block diagram of the server of FIG. 1. Server 107 typically comprises processor or microprocessor controller 303 that is communicatively coupled with various system components, including transmitter 301, receiver 302, and general storage component 305. Only a limited number of system elements are shown for ease of illustration; but additional such elements may be included in the server 107.

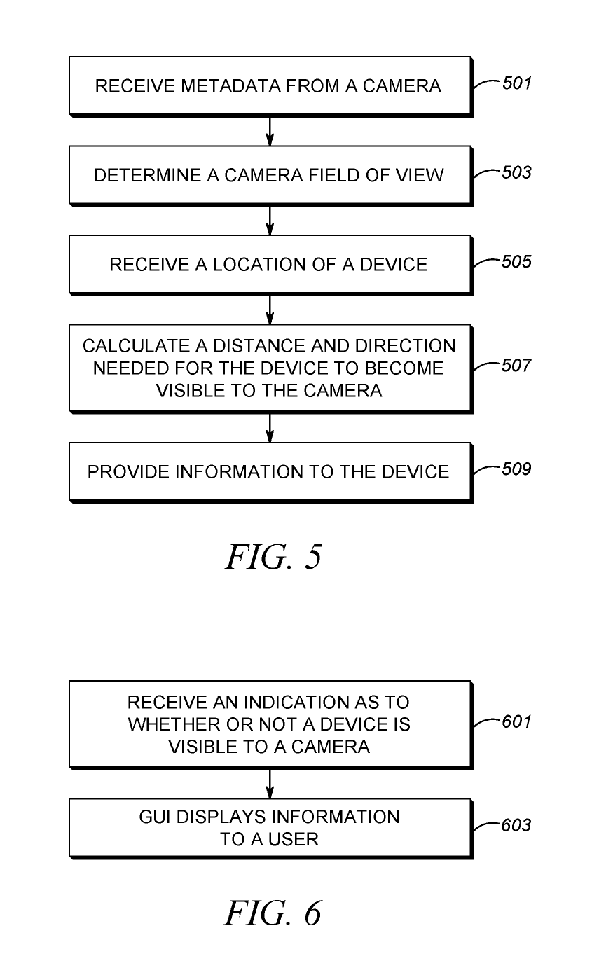

Processing device 303 may be partially implemented in hardware and, thereby, programmed with software or firmware logic or code for performing functionality described in FIG. 5. The processing device 303 may be completely implemented in hardware, for example, as a state machine or ASIC (application specific integrated circuit).

Storage 305 can include short-term and/or long-term storage (e.g., RAM, and/or ROM) and serves to store various information needed to determine whether or not a device is within a field of view of a camera (i.e., visible to the camera). Storage 305 may further store software or firmware for programming the processing device 303 with the logic or code needed to perform its functionality.

Transmitter 301 and receiver 302 are common circuitry known in the art for communication utilizing a well known communication protocol, and serve as means for transmitting and receiving messages. For example, receiver 302 and transmitter 301 may be well known long-range transceivers that utilize the Apco 25 (Project 25) communication system protocol. Other possible transmitters and receivers include, IEEE 802.11 communication system protocol, transceivers utilizing Bluetooth, HyperLAN protocols, or any other communication system protocol. Server 107 may contain multiple transmitters and receivers, to support multiple communications protocols.

In a first embodiment processor 303 receives metadata for multiple cameras 105. This information may be received by receiver 302 or may have been received by other means and stored in storage 305. Processor 303 also receives a current location and potentially the orientation of a user device 103. Again, this information may be received via receiver 302 receiving transmissions from device 103. Based on this information, processor 303 calculates whether or not device 103 is within any camera's field of view. Processor 303 may also calculate a distance and direction needed for device 103 to become visible by any camera. This information is provided to transmitter 301 and transmitted to device 103 through intervening network 106.

FIG. 4 is a block diagram of a user device of FIG. 1. User device 103 typically comprises processor 403 that is communicatively coupled with various system components, including transmitter 401, receiver 402, general storage component 405, context-aware circuitry 407, and a user interface (GUI) 411. Only a limited number of system elements are shown for ease of illustration; but additional elements may be included in the user device 103.

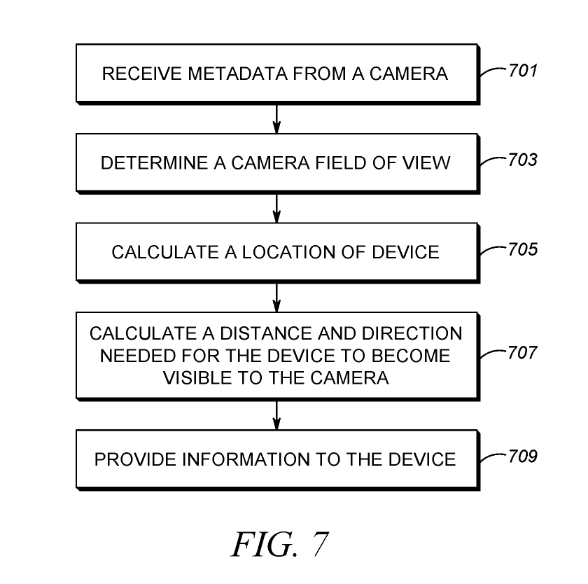

Processing device 403 may be partially implemented in hardware and, thereby, programmed with software or firmware logic or code for performing functionality described in FIG. 6 and FIG. 7. The processing device 403 may be completely implemented in hardware, for example, as a state machine or ASIC (application specific integrated circuit). Storage 405 can include short-term and/or long-term storage of various information needed for determining whether or not device 103 is within a field of view of a camera. Storage 405 may further store software or firmware for programming the processing device 403 with the logic or code needed to perform its functionality.

User interface 411 provides a way of conveying (e.g., graphical and/or audio means) information to the user. In particular, in an embodiment, information as to whether or not device 103 is visible to any camera is provided. When not visible (or poorly visible) to any camera, information as to a direction and distance to travel may be provided to a user of device 103 via the graphical user interface 411. User interface 411 may include a touchscreen, a display/monitor, a mouse/pointing means, and/or various other hardware components to provide a man/machine interface.

Context-aware circuitry 407 preferably comprises a GPS receiver and a compass that identifies a location and direction of device 103. For example, circuitry 407 may determine that device 103 is located at a particular latitude and longitude, and pointing North.

Transmitter 401 and receiver 402 are common circuitry known in the art for communication utilizing a well known communication protocol, and serve as means for transmitting and receiving messages. For example, receiver 402 and transmitter 401 may be well known long-range transceivers that utilize the Apco 25 (Project 25) communication system protocol. Other possible transmitters and receivers include, IEEE 802.11 communication system protocol, transceivers utilizing Bluetooth, HyperLAN protocols, or any other communication system protocol. User device 103 may contain multiple transmitters and receivers, to support multiple communications protocols.

In an embodiment where server 107 calculates whether or not device 103 is visible to any camera, circuitry 407 will use transmitter 401 to transmit location and direction information to server 107. In response, receiver 402 will receive information from server 107 that indicates whether or not device 103 is within any camera's field of view. Information as to a direction and distance needed to become visible to any camera may be additionally received from server 107. User interface 411 will be used to provide this information to the user of device 103.

In an embodiment where device 103 is calculating whether or not it is visible to any camera, processor 403 receives metadata for multiple cameras 105. This information may be received by receiver 402 or may have been received by any means prior, and stored in storage 405. Processor 403 also receive a current location and potentially the orientation of user device 103 from circuitry 407. Based on this information, processor 403 calculates whether or not device 103 is within any camera's field of view. Processor 403 may also calculate a distance and direction needed for device 103 to become visible by any camera. This information is provided to user interface 411.

FIG. 5 is a flow chart showing operation of the server of FIG. 3 in accordance with the first embodiment. The logic flow begins at step 501 where receiver 302 receives metadata from a camera. As discussed above, the metadata may comprise location information along with other information used to determine a camera's field of view. At step 503, logic circuitry 303 uses the information received from the camera to determine a camera's field of view. More particularly, a three dimensional geographic area is determined that will be adequately captured by the camera. This may be accomplished by determining the location, elevation, tilt, and direction, and focal length of the camera. This information may be used to calculate a field of view (also known as field of vision, or instantaneous field of view) which comprises the extent of the observable world that is seen at any given moment by a camera. In case of optical instruments or sensors it is a solid angle through which a detector is sensitive to electromagnetic radiation. The current focal length of a camera may be taken into consideration so that objects beyond a certain distance from the camera may be deemed not within a field of view of the camera.

At step 505, receiver 302 receives a current three dimensional location of device 103. A device orientation may also be received at step 505. Logic circuitry 303 uses this information to calculate a distance and direction needed for device 103 to become adequately visible to the camera (step 507). More particularly, logic circuitry 303 determines a distance and direction needed for device 103 to be within the three dimensional geographic area calculated at step 503. This information is provided to device 103 via transmitter 301 (step 509).

As described above, a method for notifying a user when they are within a camera's field of view is provided. During operation a server receives metadata from a camera; the server determines a camera's field of view from the metadata, the server receives a location of a device, the server calculates whether or not the device is within the camera's field of view based on the location of the device and the camera's field of view, and the server provides information to the device that indicates whether or not the device is within the camera's field of view.

The metadata received from the camera may comprise metadata received over a network from a camera remote to the server. The location of the device comprises may be received over a network from the device that is remote to the server. The step of providing the information to the device may comprise the step of providing the information to the device remote to the server, wherein the information is provided over a network to the device.

FIG. 6 is a flow chart showing operation of the user device of FIG. 4 in accordance with a first embodiment. In particular, the logic flow of FIG. 6 shows those steps (not all are necessary) for device 103 to receive information from server 107 indicating whether or not device 103 is within a camera's field of view. The logic flow begins at step 601 where receiver 402 receives an indication as to whether or not device 103 is within a camera's field of view. Additional information may be received at step 601, such as, but not limited to a distance and direction needed to travel so that device 103 is within a camera's field of view. The logic flow continues to step 603 where logic circuitry 403 instructs GUI 411 to display information on whether or not the device is within a camera's field of view. The information displayed may comprise information on the distance and direction of travel needed to place device 103 within a camera's field of view.

FIG. 7 is a flow chart showing operation of the user device of FIG. 4 in accordance with a second embodiment. In particular, the logic flow of FIG. 7 shows those steps (not all are necessary) for device 103 to calculate whether or not device 103 is within a camera's field of view. The logic flow begins at step 701 where receiver 402 receives metadata from a camera. As discussed above, the metadata may comprise location information along with other information used to determine a camera's field of view. At step 703, logic circuitry 403 uses the information received from the camera to determine a camera's field of view. More particularly, a three dimensional geographic area is determined that will be adequately captured by the camera. This may be accomplished as discussed above with reference to FIG. 5.

At step 705, context-aware circuitry 407 calculates a current location for device 103. A device orientation may also be calculated at step 705. Logic circuitry 403 uses this information to calculate a distance and direction needed for device 103 to become adequately visible to the camera (step 707). More particularly, logic circuitry 403 determines a distance and direction needed for device 103 to be within the three dimensional geographic area calculated at step 703. This information is provided to a user via GUI 411 (step 709).

As described above, a method for notifying a user when they are within a camera's field of view is accomplished by a device receiving metadata from a camera, the device determining a camera's field of view from the metadata, the device determining a location of the device, the device calculating whether or not the device is within the camera's field of view based on the location of the device and the camera's field of view, and the device providing information to a user that indicates whether or not the device is within the camera's field of view.

The step of receiving metadata from the camera may comprise receiving metadata over a network from a camera remote to the device. While the step of determining the location of the device may comprise the step of receiving the location of the device from hardware internal to the device.

In the foregoing specification, specific embodiments have been described. However, one of ordinary skill in the art appreciates that various modifications and changes can be made without departing from the scope of the invention as set forth in the claims below. For example, a user of device 103 may be notified about camera visibility by integrating the above technique with audio, vibration, and/or a light indicator on device 103. Additionally, if a location of obstructing devices (e.g., large trucks) are known, these may be taken into consideration when calculating whether or not a device is visible to a camera. Additionally, in situations where a pan/tilt/zoom schedule is being utilized by a camera, schedule information may be provided as metadata and used as described above to notify a user when (i.e., what future time) they will be within the camera field of view. In addition, weather conditions may be obtained via any on-line web site and used to determine whether or not the device is within a camera field of view. For example, if hard rain or fog is identified at a particular camera site, it may be factored into whether or not the device is within the field of view. For example, the distance from the camera identified as being within the field of view may be decreased when rain or fog is detected. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for notifying a user when they are within a camera's field of view, the method comprising the steps of:
a server receiving metadata from a camera;
the server determining a camera's field of view from the metadata;
the server receiving a location of a device;
the server calculating whether or not the device is within the camera's field of view based on the location of the device and the camera's field of view;
the server providing information to the device that indicates whether or not the device is within the camera's field of view.

2. The method of claim 1 wherein the step of receiving metadata from the camera comprises the step of receiving metadata over a network from a camera remote to the server.

3. The method of claim 1 wherein the step of receiving the location of the device comprises the step of receiving the location over a network from the device that is remote to the server.

4. The method of claim 1 wherein the step of providing the information to the device comprises the step of providing the information to the device remote to the server, wherein the information is provided over a network to the device.

5. The method of claim 1 wherein the device is taken from the group consisting of a standalone display or monitor, a handheld computer, a tablet computer, a mobile phone, a police radio, a media player, and a personal digital assistant (PDA).

6. A method for notifying a user when they are within a camera's field of view, the method comprising the steps of:
a device receiving metadata from a camera;
the device determining a camera's field of view from the metadata;
the device determining a location of the device;
the device calculating whether or not the device is within the camera's field of view based on the location of the device and the camera's field of view;
the device providing information to a user that indicates whether or not the device is within the camera's field of view.

7. The method of claim 6 wherein the step of receiving metadata from the camera comprises the step of receiving metadata over a network from a camera remote to the device.

8. The method of claim 6 wherein the step of determining the location of the device comprises the step of receiving the location of the device from hardware internal to the device.

9. The method of claim 6 wherein the device is taken from the group consisting of a standalone display or monitor, a handheld computer, a tablet computer, a mobile phone, a police radio, a media player, and a personal digital assistant (PDA).

10. An apparatus comprising:
logic circuitry receiving metadata from a camera, determining a camera's field of view from the metadata, a location of a device, and calculating whether or not the device is within the camera's field of view based on the location of the device and the camera's field of view;
transmission circuitry transmitting information on whether or not the device is within a camera field of view over a network to the remote device.

11. The apparatus of claim 10 wherein the device is taken from the group consisting of a standalone display or monitor, a handheld computer, a tablet computer, a mobile phone, a police radio, a media player, and a personal digital assistant (PDA).

12. The apparatus of claim 10 wherein the metadata comprises a pan/tilt/zoom schedule for the camera, and the information transmitted to the user comprises a future time when the device will be within the field of view of the camera.

13. The apparatus of claim 10 wherein weather conditions are obtained by the logic circuitry and are utilized in determining whether or not the device is within the field of view.
